(19) United States
(12) Patent Application Publication
(10) Pub. No.: US 2012/0180500 A1
(43) Pub. Date: Jul. 19, 2012

(54) SYSTEM FOR DAMPING VIBRATION IN A GAS TURBINE ENGINE

(75) Inventor: Richard Martin DiCintio, Greenville, SC (US)

(73) Assignee: GENERAL ELECTRIC COMPANY, Schenectady, NY (US)

(21) Appl. No.: 13/006,327

(22) Filed: Jan. 13, 2011

(51) Int. Cl. F02C 3/14; B23P 17/00

(52) U.S. Cl. 60/796; 29/888

(57) ABSTRACT

A system, including, a turbine combustor, including, a first wall disposed about a flow path of hot combustion gases, a second wall disposed about the first wall, and a damping system disposed between the first and second walls, wherein the damping system is configured to dampen vibration, and the damping system is tuned to dynamic drivers in the turbine combustor.

### BACKGROUND OF THE INVENTION

The subject matter disclosed herein relates to gas turbine engines, and more specifically, to an impingement sleeve damping system.

In general, gas turbines combust a mixture of compressed air and fuel to produce hot combustion gases. Unfortunately, combustion dynamics and high velocity gas flows within the gas turbine engine may cause vibration that can lead to damage of turbine components. For example, the vibration can lead to damage of combustor components, such as an impingement sleeve.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a turbine combustor, including, a first wall disposed about a flow path of hot combustion gases, a second wall disposed about the first wall, and a damping system disposed between the first and second walls, wherein the damping system is configured to dampen vibration, and the damping system is tuned to dynamic drivers in the turbine combustor.

In a second embodiment, a system includes a turbine combustor damper configured to mount between first and second walls disposed about a flow path of hot combustion gases, wherein the turbine combustor damper is configured to dampen vibration, and the turbine combustor damper is tuned to dynamic drivers including combustion dynamics.

In a third embodiment, a method includes obtaining data relating to vibration in a turbine engine, and designing a turbine combustor damper tuned to the vibration, wherein the turbine combustor damper is configured to mount between first and second walls of a turbine combustor.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic flow diagram of an embodiment of a gas turbine engine that may employ an impingement sleeve damping system;

FIG. 2 is a partial cross-sectional view of an embodiment of a combustor having an impingement sleeve damping system;

FIG. 3 is a sectional view of an embodiment of a coupling region having a damping system taken within line 3-3 of FIGS. 1 and 2;

FIG. 4 is a sectional view of an embodiment of the coupling region having a damping system taken within line 4-4 of FIG. 3;

FIG. 5 is a front view of an embodiment of a damping system;

FIG. 6 is a front view of an embodiment of a damping system that has multiple damping fingers;

FIG. 7 is a front view of an embodiment of a damping system;

FIG. 8 is a partial perspective view of an embodiment of the damping system of FIG. 5, illustrating a 180 degree section;

FIG. 9 is a partial perspective view of an embodiment of the damping system of FIG. 8 taken within line 9-9;

FIG. 10 is a perspective view of an embodiment of a damping finger;

FIG. 11 is a perspective view of an embodiment of a damping finger as illustrated in FIG. 6;

FIG. 12 is a side view of an embodiment of a damping finger with multiple layers;

FIG. 13 is a side view of an embodiment of a damping finger with multiple layers of different lengths;

FIG. 14 is a side view of an embodiment of a damping finger with apertures that vary in size;

FIG. 15 is a top view of an embodiment of the damping finger of FIG. 14;

FIG. 16 is a side view of an embodiment of a damping finger that changes in thickness;

FIG. 17 is a top view of an embodiment of the damping finger of FIG. 16;

FIG. 18 is a side view of an embodiment of the damping system between the transition piece and the impingement sleeve;

FIG. 19 is a side view of an embodiment of the damping system between the transition piece and the impingement sleeve;

FIG. 20 is a side view of an embodiment of the damping system between the transition piece and the impingement sleeve;

FIG. 21 is a side view of an embodiment of the damping system between the transition piece and the impingement sleeve; and

FIG. 22 is a flow chart of an embodiment illustrating the steps for designing and mounting a damping system in a turbine engine.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments dampen vibration in a gas turbine caused by dynamic drivers such as combustion dynamics, fluid dynamics, and so forth. In particular, the disclosed embodiments include a damping system configured to dampen vibration in a combustor of the gas turbine, e.g., an impingement sleeve. The damping system may include a plurality of damping fingers or a multi-finger damping structure disposed along the impingement sleeve. In some embodiments, the damping fingers may include different shapes, different thicknesses, multiple layers, different materials, and other variations to dampen the vibration based on various parameters. Thus, the disclosed embodiments of the damping system (e.g., damping fingers) may be tuned to combustion dynamics, fluid dynamics, and other drivers in each combustor and gas turbine.

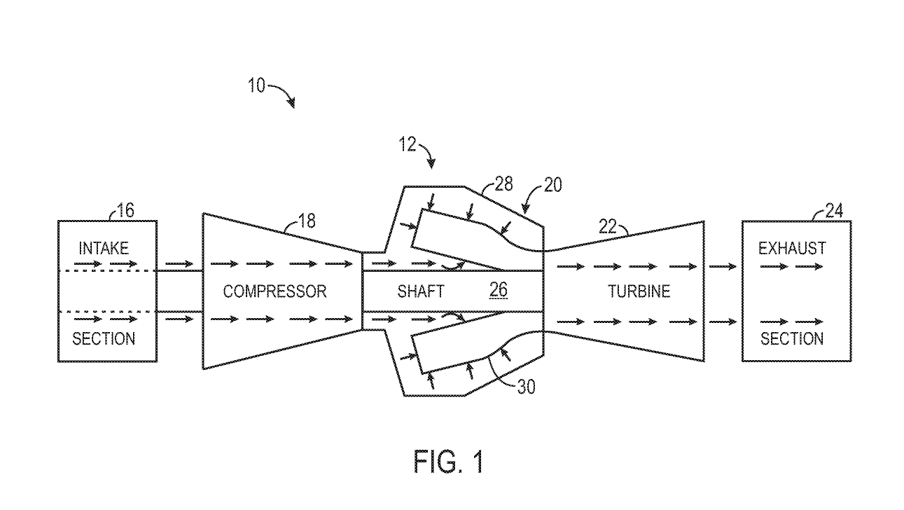

Turning to the figures, FIG. 1 is a block diagram of an exemplary system 10 including a gas turbine engine 12 that may include an impingement sleeve damping system. In certain embodiments, the system 10 may include an aircraft, a watercraft, a locomotive, a power generation system, or combinations thereof. The illustrated gas turbine engine 12 includes an air intake section 16, a compressor 18, a combustor section 20, a turbine 22, and an exhaust section 24. The turbine 22 is coupled to the compressor 18 via a shaft 26.

As indicated by the arrows, air may enter the gas turbine engine 12 through the intake section 16 and flow into the compressor 18, which compresses the air prior to entry into the combustor section 20. The illustrated combustor section 20 includes a combustor housing 28 disposed concentrically or annularly about the shaft 26 between the compressor 18 and the turbine 22. The compressed air from the compressor 18 enters combustors 30 where the compressed air may mix and combust with fuel within the combustors 30 to drive the turbine 22. From the combustor section 20, the hot combustion gases flow through the turbine 22, driving the compressor 18 via the shaft 26. For example, the combustion gases may apply motive forces to turbine rotor blades within the turbine 22 to rotate the shaft 26. After flowing through the turbine 22, the hot combustion gases may exit the gas turbine engine 12 through the exhaust section 24.

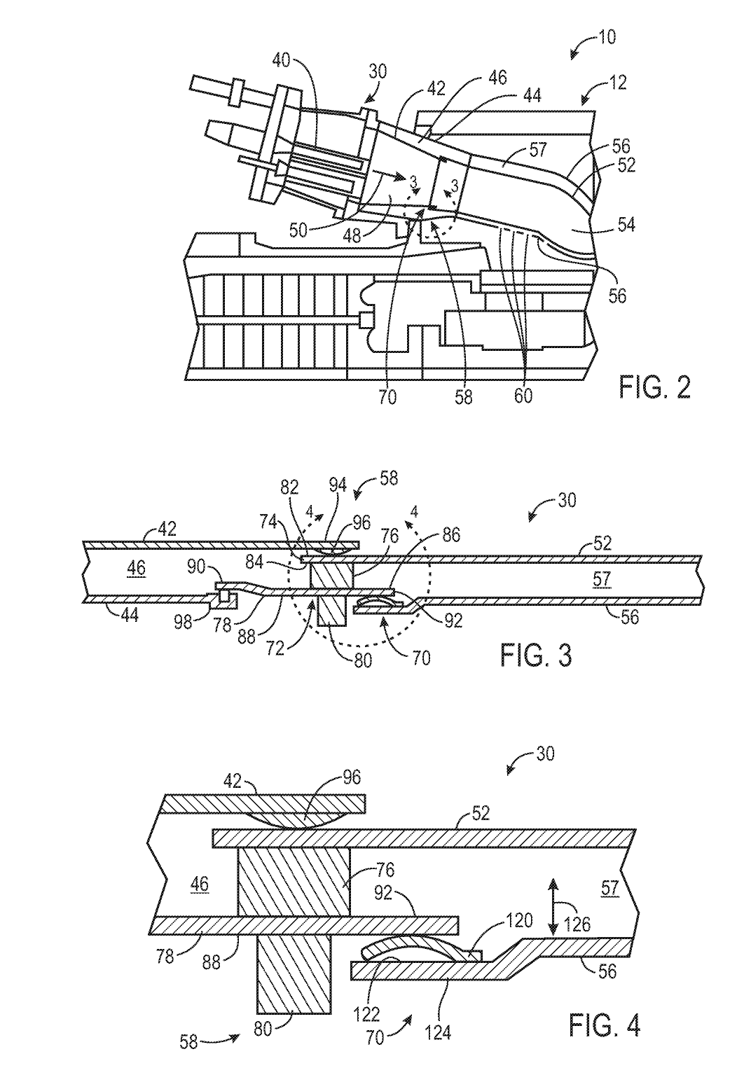

FIG. 2 shows a sectional side view of an embodiment of the turbine system 10. As depicted, the embodiment includes an annular array of combustors 30 (e.g., 6, 8, 10, 12 or more combustors 30). Each combustor 30 includes at least one fuel nozzle 40 (e.g., 1, 2, 3, 4, 5, 6, 7, 8, 9, 10, or more), a combustor liner 42, and a flow sleeve 44 surrounding the combustor liner 42. The arrangement of the liner 42 and the flow sleeve 44, as shown in FIG. 2, is generally concentric and may define an annular passage 46. The interior of the liner 42 may define a substantially cylindrical combustion chamber 48. The flow sleeve 44 may include a plurality of inlets, which provide a flow path for at least a portion of the air from the compressor 18 into the annular passage 46. In other words, the flow sleeve 44 may be perforated with a pattern of openings to define a perforated annular wall.

Inside the combustion chamber 48, fuel and air mix and combust to generate hot combustion gases, which flow in a downstream direction 50 away from the fuel nozzles 40. As used herein, the terms “upstream” and “downstream” shall be understood to relate to the flow of combustion gases in the gas turbine engine 12. As the combustion gases flow in the downstream direction 50, the combustion gases pass through a transition piece 52 toward the turbine 22. An interior cavity 54 of the transition piece 52 generally provides a path by which combustion gases from the combustion chamber 48 may be directed into the turbine 22. Surrounding the transition piece 52 may be an impingement sleeve 56. The impingement sleeve 56 defines apertures 60 that direct cooling airflow around the transition piece 52 in an annular passage 57. In the depicted embodiment, liner 42, flow sleeve 44, transition piece 52, and impingement sleeve 56 may all connect in a coupling region 58. As discussed below, the coupling region 58 may include a damping system 70 configured to protect the impingement sleeve 56 from damage due to vibration caused by combustion dynamics, fluid dynamics, and other drivers. For example, the damping system 70 may dampen vibration to reduce the possibility of the impingement sleeve vibrating at its natural frequency.

As discussed above, the turbine system 10, in operation, may intake air through the air intake 16. The compressor 18, which is driven by the shaft 26, rotates and compresses the air. The compressed air then contacts the impingement sleeve 56 and passes through its apertures 60. As the compressed air passes through the apertures 60, it cools the transition piece while being channeled upstream (e.g., in the direction of fuel nozzles 40), such that the air flows over the transition piece 52. The airflow then continues upstream into the annular passage 46 towards the fuel nozzles 40, where the air mixes with fuel 14 and is ignited within the combustion chamber 48. The resulting combustion gases are channeled from the chamber 48 into the transition piece cavity 54 and to the turbine 22.

FIG. 3 is a sectional view of an embodiment of the coupling region 58 having a damping system 70 taken within line 3-3 of FIGS. 1 and 2. As discussed above, the coupling region 58 is the location where the liner 42, transition piece 52, flow sleeve 44, and impingement sleeve 56 connect. More specifically, the liner 42, flow sleeve 44, and impingement sleeve 56 all connect to a transition piece forward frame 72. The forward frame 72 includes a transition piece end 74, spacer 76, arm 78, and spacer 80.

In the present embodiment, transition piece end 74 includes an inner surface 82 and an outer surface 84. The arm 78 likewise includes an inner surface 86 and an outer surface 88, as well as, a first end 90 and a second end 92. The spacer 76 couples the outer surface 84 of the transition piece forward end 74 and the inner surface 86 of the arm 78. As explained above, the liner 42, flow sleeve 44, and impingement sleeve 56 all connect to the transition piece forward frame 72. Specifically, the liner 42 defines an end 94 with a spacer 96. As illustrated, the spacer 96 connects to the inner surface 82 of the transition piece end 74, thus, connecting the liner 42 to the transition piece 52. Furthermore, the arm 78 connects to the flow sleeve 44 and the impingement sleeve 56 on its outer surface 88. More specifically, the first end 90 of the arm 78 connects to an end 98 of the flow sleeve 44. The second end 92 of the arm 78 connects to the impingement sleeve 56 via the damping system 70. As explained above, the damping system 70 may prevent damage to the impingement sleeve 56 caused by the impingement sleeve 56 vibrating, e.g., at its natural frequency. In order words, the damping system 70 may dampen vibration caused by dynamic drivers, such as combustion dynamics, or fluid dynamics. Accordingly, the damping system 70 may increase the life of the impingement sleeve 56 and reduce down time of the gas turbine engine 12.

FIG. 4 is a sectional view of an embodiment of the coupling region 58 having a damping system 70 taken within line 4-4 of FIG. 3. As illustrated in FIG. 4, the damping system 70 includes a damping finger 120. The damping finger 120 contacts both the inner surface 122 of impingement sleeve end 124 and the bottom surface 88 of the arm 78. The stiffness of this damping finger 120 can be varied such that the natural frequency of the impingement sleeve 56 is tuned away from the dynamic drivers. Thereby reducing the possibility of damage to the impingement sleeve 56 and possibly other components within the turbine engine 12.

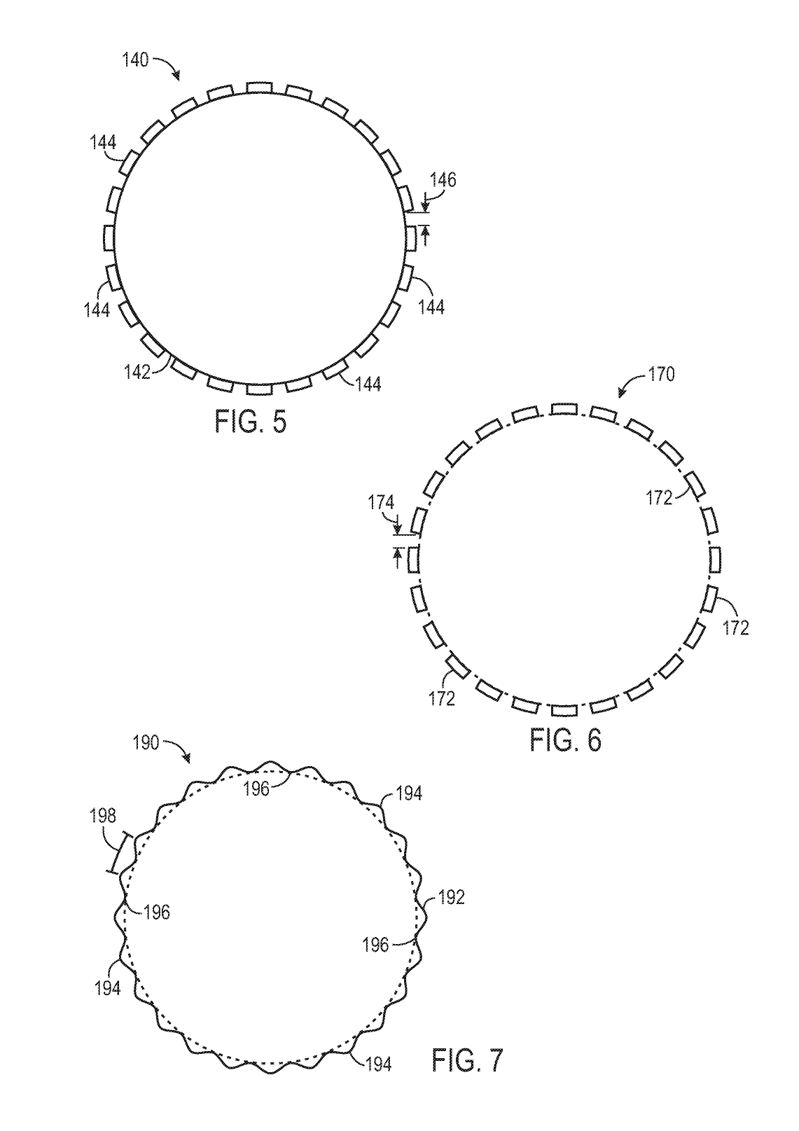

FIG. 5 is a front view of an embodiment of a damping system 140 that may be disposed in the coupling region 58. The damping system 140 includes a band 142 (e.g., annular band) and damping fingers 144 attached to the band 142. Accordingly, the band 142 may wrap completely around the inner surface 122 of the impingement sleeve 56 as illustrated in FIG. 4. In the illustrated embodiment, the fingers 144 are the same as one another about the band 142. In other embodiments, the fingers 144 may vary in dimensions, shape, material, spacing, and other characteristics about the band 142. For example, some damping fingers 144 may be formed out of a more flexible material, while other damping fingers 144 may be formed out of a stiffer material. Thus, the damping fingers 144 may be specifically tuned to expected vibration at different positions about the band 142, and thus different positions about the combustor 30. As illustrated, the damping fingers 144 may be equally spaced from one another by a distance 146. In other embodiments, the spacing 146 between damping fingers 146 may vary. Thus, damping fingers 144 may be concentrated closer together at locations that require additional stiffness or greater support and spaced further apart at locations that require less damping or stiffness. Finally, while FIG. 5 illustrates the damping system 140 with 24 damping fingers 144, the system 140 may include any number of damping fingers 144, e.g., 1 to 100 or more.

FIG. 6 is a front view of an embodiment of a damping system 170 that has multiple discrete damping fingers 172. In contrast to the damping system 170 of FIG. 5, the damping system 170 does not include the band 142 connecting the fingers 172 together. Instead, the fingers 172 are independent and may be individually mounted onto the interior surface 122 of the impingement sleeve 56 or on the outer surface 88 of the arm 78 as illustrated in FIG. 4. In the illustrated embodiment, each of the fingers 172 is the same as the other fingers 172. In some embodiments, the fingers 172 may vary in dimensions, shape, material, spacing, or other characteristics relative to the other fingers 172. For example, some damping fingers 172 may be formed out of a more flexible material, while other damping fingers 172 may be formed out of a stiffer material. Thus, the damping fingers 172 may be tuned to specific vibrational frequencies at different positions about the combustor 30. Furthermore, in the present embodiment, the damping fingers 172 may be equally spaced from one another by a distance 174. In other embodiments, the spacing 174 between damping fingers 174 may vary. Thus, damping fingers 172 may be concentrated closer together at locations that require additional stiffness or greater support and spaced further apart at locations that require less damping or stiffness. Finally, while FIG. 6 illustrates the damping system 170 with 24 damping fingers 172, the system 170 may include any number of damping fingers 172, e.g., 1 to 100 or more.

FIG. 7 is a front view of an embodiment of a damping system 190. As illustrated, the damping system 190 includes a band 192 with alternating protrusions 194 and depressions 196. The depressions 196 may contact the exterior surface 88 of the arm 78 while the protrusions 191 contact the interior surface 122 as illustrated in FIG. 4. In the illustrated embodiment, the protrusions 194 may be equally spaced from one another by a distance 198. In other embodiments, the spacing 198 between protrusions 196 may vary. Thus, protrusions 196 may be concentrated closer to together at locations that require additional stiffness or greater support, and spaced further apart at locations that require less damping or stiffness. Furthermore, while FIG. 7 illustrates the damping system 190 with 24 damping protrusions 194, the system 190 may include any number of damping protrusions 194 and the corresponding depressions 196, e.g., 10 to 100 or more. Finally, the band 192 may not be a single 360-degree unitary structure but may instead include multiple sections. For example, the band 192 may include 1 to 20, 1 to 10, 2 to 4, or any other number of sections. Each of the sections may represent a specific arc length that is equal to or different from the other sections. For example, the sections may include arc lengths of 15, 30, 45, 60, 90, or 180 degrees. By further example, the band 192 may include 10 sections each having a 36 degree arc length. Furthermore, each of these sections may include any number of protrusions and depressions 194, 196, and each of these sections may have identical or different constructions (e.g., material, shape, thickness, etc.).

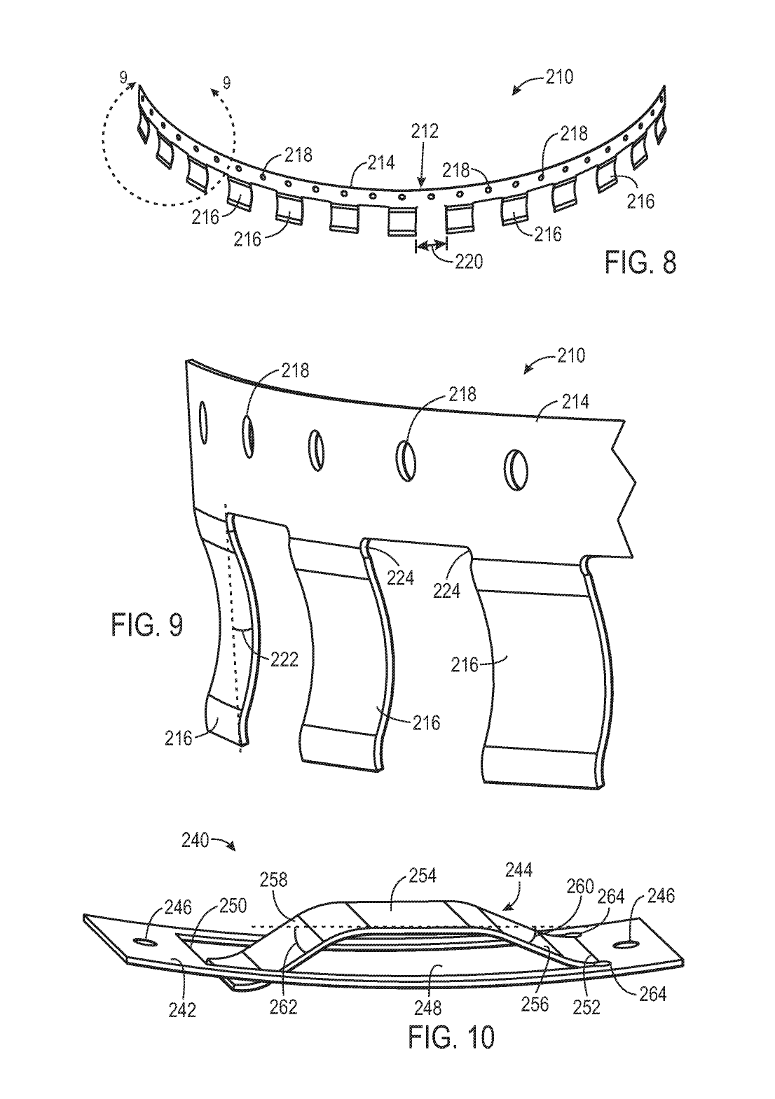

FIG. 8 is a partial perspective view of an embodiment of a damping system 210 such as the damping system 140 of FIG. 5. In particular, FIG. 8 illustrates a 180-degree section 212, which may be combined with another 180 degree section 212 to provide a full 360 band of damping fingers 216 about the combustor 30, e.g., impingement sleeve 56. The section 212 includes a band portion 214, damping fingers 216, and attachment apertures 218. As illustrated, each of the damping fingers 216 may be spaced an equal distance 220 apart from one another. In some embodiments, the spacing 220 may be varied (e.g., uniform or non-uniform) to tailor the amount of damping fingers 216 by e.g., closer spacing 220 in regions with greater damping needs and/or greater spacing 220 in regions with lesser damping needs. Furthermore, the damping system 210 may include any number of sections 212 of various arc lengths. For example, the damping system 210 may include multiple sections that represent specific arc lengths of 10, 20, 30, 40, 50, 60, 70, 80, 90, or 180 degrees in various combinations. For example, the damping system 210 may include 10 sections 212 with a 36 degree arc length, 20 sections 212 with an 18 degree arc length, 4 sections 212 with a 90 degree arc length, or 8 sections 212 with a 45 degree arc length. The sections 210 may be identical or different from one another in various ways, such as the number and spacing of damping fingers 216, the materials, the geometry of the damping fingers 216, and/or the stiffness of the damping fingers 216. For example, the sections 212 and/or damping fingers 216 may be tuned to dampen certain vibrational frequencies or amplitudes.

FIG. 9 is a partial perspective sectional view of an embodiment of the damping system of FIG. 8 taken within line 9-9. As illustrated, the band 214 includes apertures 218. The apertures 218 facilitate attachment and alignment of the damping system 210 between the arm 78 and the impingement sleeve 56 of FIG. 4. The damping system 210 may include any number of apertures 218 depending on the design, e.g., 1 to 100 or more apertures 218. In some embodiments, the apertures 218 may be replaced with other mounting hardware or fasteners such as welded joints. In the illustrated embodiment, the damping fingers 216 define a curvature 222 with respect to the band portion 214 (i.e., common mount). The curvature 222 (e.g., radius of curvature) of the damping fingers 216 may depend on the distance between the arm 78 and impingement sleeve end 124. Thus, with greater distance between the arm 78 and the impingement sleeve end 124, the curvature 222 of the damping finger 216 may increase. The curvature 222 may be selected to control the stiffness of the damping finger 216 along with other parameters, such as the material, thickness, and continuity (e.g., perforations) or no perforations of the finger 216. The curvature 222 of the damping finger 216 facilitates the damping of dynamic drivers that may cause the impingement sleeve 56 to vibrate at its natural frequency, causing damage. Finally, the damping system 210 may include grooves 224 between the band portion 214 and the damping fingers 216. The grooves 224 may reduce stress in the damping fingers 216.

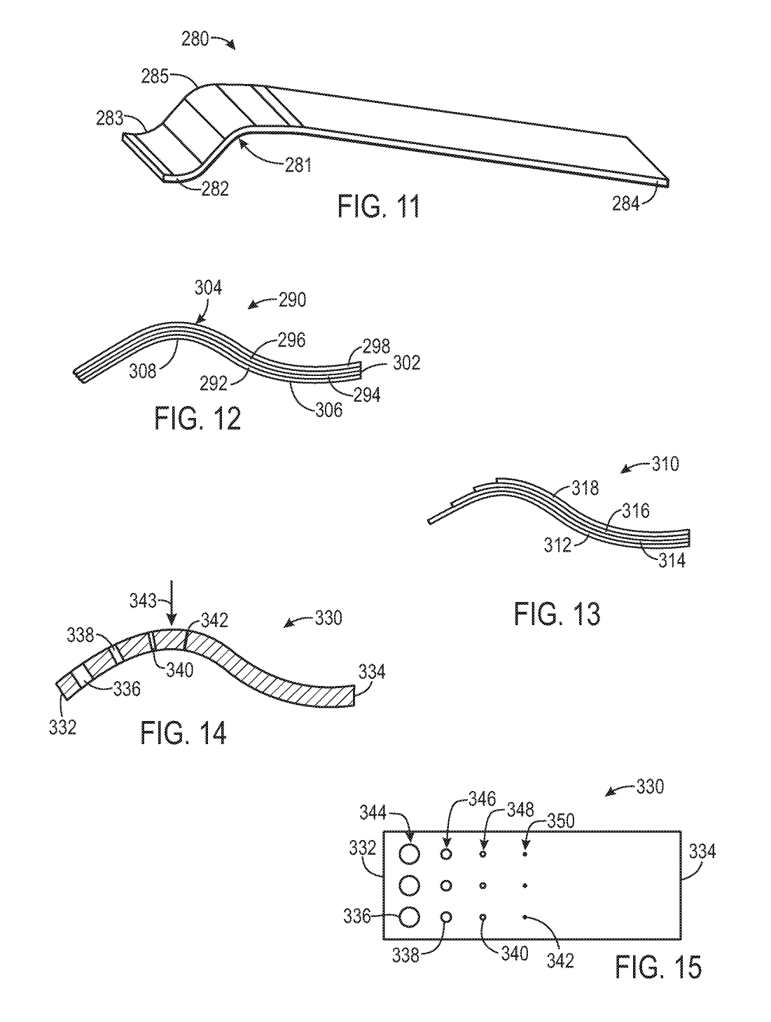

FIG. 10 is a perspective view of an embodiment of a damping finger 240. The damping finger 240 includes a platform portion 242 (i.e., independent mount) and a finger portion 244. As illustrated, the platform 242 is rectangular in shape, with apertures 246, and finger aperture 248. The apertures 246 may facilitate attachment to either the arm 78 or the impingement sleeve end 124, while aperture 248 provides space for finger 244 to expand and contract. The aperture 248 defines a first end 250 and a second end 252. In the present embodiment, the finger 244 attaches to the second end 252 and generally forms a curved shape as it extends through the aperture 248 in the direction of end 250. For example, the finger 244 may include a flat portion 254 with a first angled portion 256 and a second angled portion 258. The first and second angled portions 256 and 258 connect to the flat portion 254 and form angles with respect to the flat portion 254. For instance, the first portion 256 may form an angle 260 with respect to the flat portion 254, while the second portion forms an angle 262 with respect to the flat portion 254. In some embodiments, the angles 260 and 262 may be the same, and in other embodiments they may differ. Furthermore, some embodiments of the finger 244 may have curved or rounded portions 254, 256, and 258, rather than flat portions. Regardless of its shape, the finger 244 has a u-shape that compresses and expands within the aperture 248. As the finger 244 compresses, it increases the natural frequency of the impingement sleeve 56, thus, preventing damage to the sleeve 56. The damping system 240 may include grooves 264 to reduce stress concentrations. The grooves 264 remove sharp corners (i.e., stress concentrations) where the first portion 256 connects to the platform 242. FIG. 11 is a perspective view of an embodiment of a damping finger 280, such as the damping fingers 172 of FIG. 6. The damping finger 280 may define a first end 282 and a second end 284. As illustrated, the damping finger 280 has a wave shape between the ends 282 and 284. For example, the damping finger 280 has an S-shaped portion 281 adjacent the first end 282. The S-shaped portion 281 includes an upwardly curved portion 283 adjacent a downwardly curved portion 285. The upwardly curved portion 283 may define a can surface 282 to enable pivotability of the finger 280 during expansion and contraction. For example, the first end 282 may be a free end, while the second end 284 may be a fixed end. In other embodiments, the damping finger 280 may define other shapes with one or more curves, e.g., 1 to 10 alternating curves. As will be discussed below in further detail the damping finger 280 may be formed out of a variety of materials, define a variety of thicknesses, and form a variety of geometries. This advantageously permits tuning of the damping finger 280 to the dynamic drivers. For example, the finger 280 may be formed out of stainless steel and have thicknesses ranging from approximately 1 to 20, 1 to 10, or 2 to 5 millimeters depending on the desired stiffness.

FIG. 12 is a side view of an embodiment of a damping finger 290 with multiple layers. As illustrated, the damping finger 290 includes layers 292, 294, 296, and 298. In other embodiments, the finger 290 may include any number of layers, e.g., 1 to 20 or more. Each of these layers may differ with respect to the others. For example, each layer may differ in the type of material and/or thickness with respect to the others, which may cause an increase or decrease in stiffness. For instance, the bottom most layer 292 may be the stiffest, while each succeeding layers increases in flexibility. In other embodiments, the top most layer may be the stiffest, while the bottom most layer may be the most flexible. In still other embodiments, the stiffness may vary with some layers having the same stiffness and other layers differing. In the illustrated embodiment, the layers 292, 294, and 296 may be fixed together along their entire length, part of their entire length, or at one or more discrete points. For example, the layers 292, 294, and 296 may be uncoupled from one another at a first end 300 and coupled together at a second end 302. Furthermore, the finger 290 may be fixed at the second end 302, and free at the first end 300. In addition, the finger 290 has a wave shape 304 defined by an upwardly curved portion 306 and a downwardly curved portion 308 (e.g., alternating curves). The wave shape 304 at lest partially controls the stiffness of the finger 290 in combination with the number, thickness, and material construction of the layers.

FIG. 13 is a side view of an embodiment of a damping finger 310 with multiple layers of different lengths. As illustrated, the damping finger 310 includes layers 312, 314, 316, and 318 that may form a wave shape. In other embodiments, the finger 310 may include any number of layers, e.g., 1, 2, 3, 4, 5, 6, 7, 8, 9, 10, 15, 25, 50, or more (i.e., variable layering). Each of these layers may be fixed together along their entire length, part of their entire length, or at discrete points, e.g., at one or both of their ends. Furthermore, each of these layers may differ in length with respect to the other layers, e.g., the bottom most layer 312 being the longest and top most layer 318 being the shortest. For example, each of the layers may differ in length by a percentage compared to an adjacent layer. For instance, layer 312 may be 5 to 50 percent longer than layer 314, layer 314 may be 5 to 50 percent longer than layer 316, and so on. In other embodiments, the length of the layers may differ by a fixed distance from one another. Accordingly, the damping finger 310 may function like a leaf spring. In still other embodiments, each of the layers may differ in the type of material and thickness with respect to the others. For instance, the bottom most layer 312 may be the thickest and/or have the stiffest material, while each succeeding layer decreases in thickness or increases in flexibility. In other embodiments, the top most layer 318 may be the stiffest, while the bottom most layer may be the most flexible. In still other embodiments, the thickness or material may vary with between layers, with some layers having the same stiffness and other layers differing.

FIG. 14 is a side view of an embodiment of a damping finger 330. The damping finger 330 defines a first end 332; second end 334; and apertures 336, 338, 340, and 342. As illustrated the damping finger 330 forms a wave shape. The apertures 336, 338, 340, and 342 reduce the amount of material in the damping finger 330, which reduces the stiffness of the finger 330. Thus, by changing aperture size the stiffness of the finger 330 may change, altering how the finger 330 dampens vibration in the turbine 10. As illustrated, each of these apertures 336, 338, 340, and 342 varies in size with respect to the other apertures. Furthermore, each of these apertures 336, 338, 340, and 342 changes in size from the first end 332 toward the second end 334 (e.g., reduces in size). In other embodiments, the reverse may be true with the apertures progressively becoming smaller towards the first end 332. In still other embodiments, the apertures 336, 338, 340, and 342 may not change or may not progressively increase/decrease in size. As illustrated, the apertures 336, 338, 340, and 342 may provide greater flexibility (lower spring force) near the first end 332, and greater stiffness (higher spring force) near the second end 334. In this manner, the finger 330 may have greater flexibility during an initial compression of the finger 330, while allowing the finger 330 to increase in stiffness as the finger is increasingly compressed in the direction of arrow 343. Furthermore, either one of the ends 332 and 334 may be fixed while the opposite end is free, thus allowing the finger 330 to elongate under compression.

FIG. 15 is a top view of an embodiment of the damping finger 330 of FIG. 14. As illustrated, the apertures 336, 338, 340, and 342 become progressively smaller the further away from the first end 332. Furthermore, the apertures 336, 338, 340, and 342 are all arranged into rows 344, 346, 348, and 350. In other embodiments, the apertures 336, 338, 340, and 342 may not all be arranged into rows, but may be arranged in columns, groups, patterns, or random order. As illustrated, each of the rows include three apertures, but other embodiments may include more apertures per row, e.g., 1, 2, 3, 4, 5, 6, 7, 8, 9, 10, 50, 100, or more apertures per row (i.e., variable amount of perforations). Furthermore, instead of varying the size of the apertures between rows, the apertures may remain the same with some rows including more apertures than other rows. For example, row 344 may include more apertures than row 350. Thus, the stiffness may progressively increase from row 344 to row 350 without changing aperture size, but instead the number of apertures. Finally, the apertures 336, 338, 340, and 342 may vary in shape with respect to each other or from row to row. For instance, the apertures may be circular, oval, triangular, square, rectangular, or other shapes.

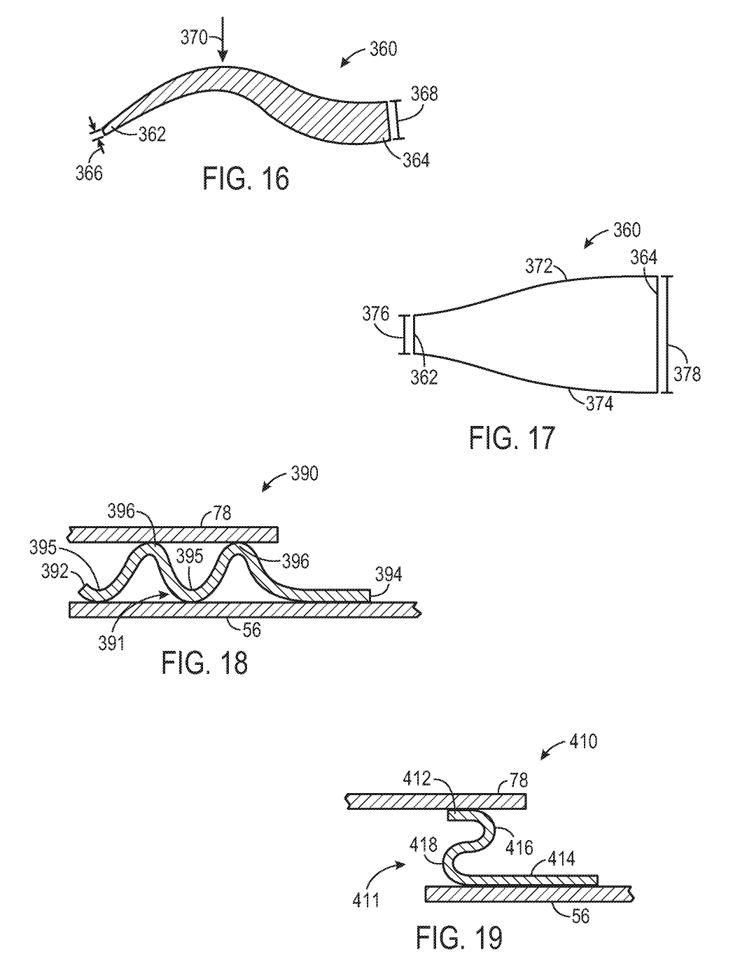

FIG. 16 is a side view of an embodiment of a wave shaped damping finger 360 that changes in thickness. The variable thickness and width damping finger 360 defines a first end 362 and a second end 364. As illustrated, the first end 362 may define a thickness of 366, and the second end 364 may define a thickness of 368. In the present embodiment, the second end thickness 368 is considerable thicker than the first end thickness 366. For example thickness may progressively change lengthwise from the first end 362 to the second end 364 by approximately 1.1 to 50, 1.1 to 25, 1.1 to 10, or 2 to 5 times. Accordingly, the finger 360 illustrates a variable cross-section that progressively increases from the first end 362 to the second end 368. The changing cross-section may vary the stiffness of the finger 360. For example, the finger 360 may be the most flexible near the end 362, and the stiffest on the opposite end (i.e., second end 364). Similar to the discussion with respect to FIG. 14, this arrangement may advantageously permit increased flexibility in an initial compression of the finger 360, while the increased thickness away from the first end 362 increases the stiffness of finger 360 as it is increasingly compressed in the direction of arrow 370, e.g., the damping force may increase in a non-linear manner. Furthermore, either end of damping finger 360 may be fixed while the opposite end is free, thus allowing the finger 360 to elongate under compression.

FIG. 17 is a top view of an embodiment of the damping finger 360 of FIG. 16. The finger 360 includes a first side 372 (e.g., curved side) and a second side 374 (e.g., curved side). In some embodiments, the distances between the sides 372 and 374 may change from the first end 362 to the second end 364. For example, the sides 372 and 374 may be separated by a distance 376 at the first end 362, while the sides 372 and 374 may be separated by a distance 378 at the second end 364. Thus, the thickness and width of finger 360 may be significantly less at end 362 than at the opposite end 364. As explained above, this may increase flexibility in the initial stages of compression, while the finger 360 may provide increasingly greater stiffness with greater compression (e.g., in a non-linear manner). Thus, the finger 360 may flex easily under light vibrations, while providing increased resistance to greater vibrations (e.g., if the impingement sleeve approaches one of its natural frequencies).

FIG. 18 is a side view of an embodiment of a damping finger 390 between the arm 78 and the impingement sleeve 56. The damping finger 390 defines a wave shaped spring 391 between a first end 392 and a second end 394. In the illustrated embodiment, the ends 392 and 394 touch the impingement sleeve 56. The wave-shaped spring 391 curves up and down (or winds back and forth) to define a plurality of upwardly curved portions 395 and a plurality of downwardly curved portions 396. For example, the illustrated wave-shaped spring 391 includes two upwardly curved portions 395 and two downwardly curved portions 396. In other embodiments, the damping finger 390 may include any number of curved portions, e.g., 1, 2, 3, 4, 5, 6, 7, 8, 9, 10, or more. In certain embodiments, the wave-shaped spring 391 may define an M-shape, a W-shape, or a plurality of U-shapes. Furthermore, either end 392 or 394 of damping finger 390 may be fixed while the opposite end is free, thus allowing the finger 390 to elongate under compression.

FIG. 19 is a side view of an embodiment of a damping finger 410 between the arm 78 and the impingement sleeve 56. The damping finger 410 defines an S-shaped spring 411 between a first end portion 412 and a second end portion 414. As illustrated, the first end portion 412 contacts the arm 78, while the second end portion 414 contacts the impingement sleeve 56. The S-shaped spring 411 includes curved portions 416 and 418 (e.g., opposite C-shaped portions). The combination of the end portions 412, 414 and the curved portions 416, 418 define an S-shape of the S-shaped spring 411. In other embodiments, the finger 410 may include any number of curved portions (e.g., alternating C-shaped portions) between the first end portion 412 and the second end portion 414 e.g., 1, 2, 3, 4, 5, 6, 7, 8, 9, 10, or more. Furthermore, one or both of the end portions 412 and 414 may be fixed to hold the damping finger 410 in place during vibration of the turbine 10.

FIG. 20 is a side view of an embodiment of a damping system 428 having a coil spring 430 between the arm 78 and the impingement sleeve 56. The spring 430 may be constructed with a material, and number of turns to define a spring force suitable for damping vibration. In certain embodiments, the damping system 428 may include a plurality of coil springs 430 disposed in an annular arrangement between the arm 78 and the impingement sleeve 56. In an embodiment with multiple springs 430, each of the springs 430 may have a different spring constant to dampen a different vibrational frequency about the combustor 30.

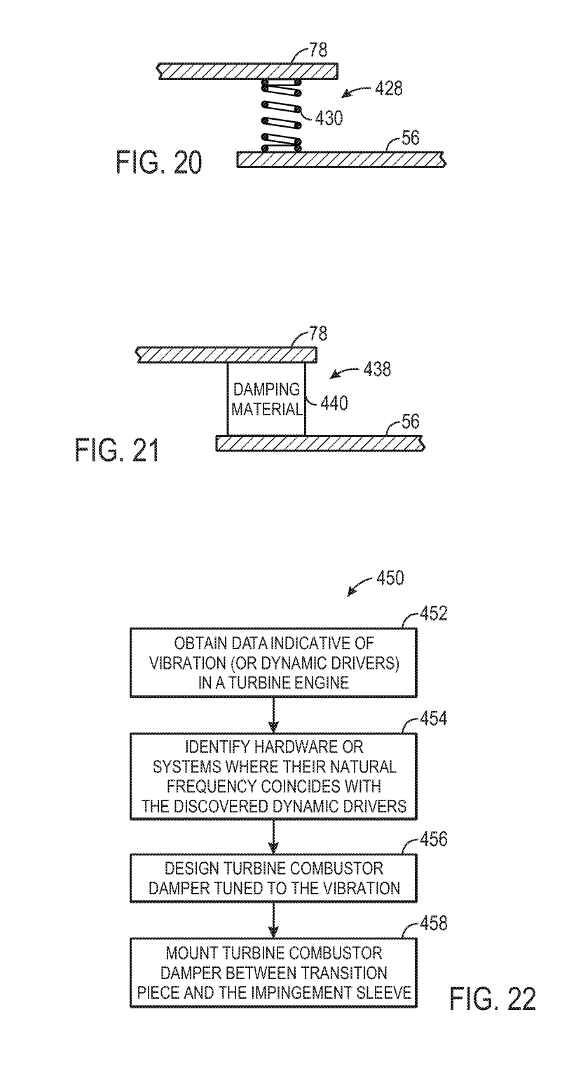

FIG. 21 is a side view of an embodiment of a damping system 438 with a damping material 440 between the arm 78 and the impingement sleeve 56. The damping material 440 may compress and expand absorbing vibrational energy generated between the arm 78 and the impingement sleeve 56. The damping material 440 may be made of one or more materials, e.g., a metal encapsulated fabric, polymer, elastomer, or fluid. The damping material 440 may be a single annular structure or a plurality of discrete elements, which extend circumferentially about the impingement sleeve 56 of the combustor 30.

FIG. 22 is a flow chart 450 of an embodiment of a process for designing and mounting a damping system in a turbine engine 10. The process 450 begins by obtaining data indicative of vibration (or dynamic drivers) in a turbine engine (block 452). After obtaining vibrational data, the process 450 identifies hardware or systems of hardware where their natural frequency coincides with the discovered dynamic drivers (block 454). The process 450 then designs a turbine combustor damper tuned to the vibration in the engine (block 456). For example, the design of the damper may take on a form as illustrated and explained in the previous FIGS. 3-21. After designing the damper, the process 450 continues by mounting the turbine combustor damper between the transition piece and the impingement sleeve (block 458). With the damper mounted between the transition piece and the impingement sleeve, the damper may protect the impingement sleeve by reducing vibrational energy in the turning engine 12.

Technical effects of the invention include the ability to dampen dynamic drivers in a combustor 30, e.g., an impingement sleeve 56. For example, the disclosed embodiments may use various damping fingers or damping devices to dampen vibrations in the impingement sleeve. The damping fingers may be layered, form different shapes, and be formed out of a variety of materials. The ability to dampen vibrations in the impingement sleeve may prevent damage associated with combustion dynamics and fluid dynamics, and increase the life of the impingement sleeve 56.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a turbine combustor, comprising:
a first wall disposed about a flow path of hot combustion gases;
a second wall disposed about the first wall; and
a damping system disposed between the first and second walls, wherein the damping system is configured to dampen vibration, and the damping system is tuned to dynamic drivers in the turbine combustor.

2. The system of claim 1, wherein the damping system comprises a damping element having at least one of a stiffness, a geometry, or a material tuned to the dynamic drivers in the turbine combustor, wherein the dynamic drivers include combustion dynamics.

3. The system of claim 1, wherein the damping system comprises a first damping finger having a first curved shape between the first and second walls.

4. The system of claim 3, wherein the damping system comprises a second damping finger having a second curved shape between the first and second walls.

5. The system of claim 4, wherein the first damping finger comprises a first mount, the second damping finger comprises a second mount, and the first and second mounts are separate from one another.

6. The system of claim 1, wherein the damping system comprises a multi-finger damping structure having a first and a second damping fingers disposed along a common mount.

7. The system of claim 3, wherein the first damping finger comprises a variable cross-section that changes lengthwise along the first damping finger.

8. The system of claim 7, wherein the variable cross-section is defined by a variable width, a variable thickness, a variable amount of perforations, or a variable layering lengthwise along the first damping finger.

9. The system of claim 1, wherein the damping system comprises a damping material or a spring.

10. The system of claim 1, wherein the damping system comprises a plurality of layers.

11. The system of claim 1, wherein the damping system comprises a damping element configured to increase a damping force in a non-linear manner in response to movement of the first and second walls toward one another.

12. The system of claim 1, comprising a transition piece having the first wall and an impingement sleeve the second wall.

13. A system, comprising:
a turbine combustor damper configured to mount between first and second walls disposed about a flow path of hot combustion gases, wherein the turbine combustor damper is configured to dampen vibration, and the turbine combustor damper is tuned to dynamic drivers including combustion dynamics.

14. The system of claim 13, wherein the first wall is part of a transition piece and the second wall is part of an impingement sleeve.

15. The system of claim 13, wherein the turbine combustor damper comprises a damping element having a stiffness, a geometry, or a material tuned to the dynamic drivers.

16. The system of claim 13, wherein the turbine combustor damper comprises a plurality of damping fingers having independent mounts.

17. The system of claim 13, wherein the turbine combustor damper comprises a damping finger having a variable cross-section that changes lengthwise along the damping finger.

18. The system of claim 13, wherein the turbine combustor damper comprises a plurality of layers.

19. A method, comprising:
obtaining data relating to vibration in a turbine engine; and
designing a turbine combustor damper tuned to the vibration, wherein the turbine combustor damper is configured to mount between first and second walls of a turbine combustor.

20. The method of claim 19, comprising installing the turbine combustor damper between the first and second walls of a transition piece of the turbine combustor.
